(19) United States
(12) Patent Application Publication
(10) Pub. No.: US 2026/0338625 A1
(43) Pub. Date: Oct. 29, 2026

(54) FIBER OPTIC PRESSURE SENSOR

(71) Applicant: General Dynamics Mission Systems, Inc., Fairfax, VA (US)

(72) Inventors: Daniel B. Cooper, Whitsett, NC (US); Stephen Rintoul, Kernersville, NC (US)

(73) Assignee: General Dynamics Mission Systems, Inc., Fairfax, VA (US)

(21) Appl. No.: 19/191,738

(22) Filed: Apr. 28, 2025

(51) Int. Cl. G01L 1/24; G01D 5/353; G01L 1/26; G01L 11/02

(52) U.S. Cl. CPC G01L 1/246; G01D 5/35367; G01L 1/26; G01L 11/025

(57) ABSTRACT

A method for estimating a hydrostatic pressure including a transmitter configured for transmitting a light pulse, a photodetector for detecting a reflection of the light pulse having a measured spectral profile from an optical fiber, and a processor for estimating a hydrostatic pressure at the position along the optical fiber in response to a frequency shift between the second spectral profile and an expected spectral profile, wherein the silica optical fiber is encapsulated by a compliant coating such that the hydrostatic pressure induces an orthogonal compression force on the complaint coating which induces an axial force on the silica optical fiber increasing a spatial period of a refractive index of the fiber Bragg grating.

### TECHNICAL FIELD

The technical field relates generally to underwater pressure sensing systems and more particularly relates to methods and apparatus for providing a fiber optic pressure sensor employing compliant optical fiber coatings combined with the use of π-phase-shifted fiber Bragg gratings to enable high resolution distributed static pressure sensing.

### BACKGROUND

Underwater pressure sensing, while crucial for various applications like oceanography and marine engineering, faces several challenges. Current sensors often struggle with accuracy and reliability due to harsh underwater conditions, including extreme pressures, temperature variations, and corrosive seawater. These factors can lead to sensor drift, requiring frequent recalibration and maintenance, which can be costly and logistically difficult. Additionally, many sensors rely on electrical signals for data transmission, which can be susceptible to interference and signal loss over long distances underwater. Furthermore, the power consumption of these sensors can be a concern, especially for long-term deployments, limiting their operational lifespan.

Underwater remote operated vehicle (ROV) location detection can be prone to errors over time due to several factors. One major challenge is the reliance on acoustic positioning systems, which can be affected by sound propagation issues in water, such as reflections and refractions caused by varying water temperatures, salinity, and pressure. These issues can lead to inaccuracies in the ROV's estimated position. Additionally, the accuracy of acoustic positioning systems can degrade over time due to factors like battery depletion and environmental wear and tear on the transponders used for location tracking. Furthermore, external factors like strong currents or obstacles can disrupt the ROV's movement, causing it to deviate from its intended path and further compounding location errors.

Pressure sensing is crucial for ROVs to maintain stable altitude and orientation, especially in dynamic underwater environments. By monitoring changes in pressure, ROVs can accurately determine their depth and adjust their buoyancy accordingly. This is particularly important for ROVs operating in deep water or performing complex maneuvers, where precise control over their position is essential. Additionally, pressure sensors can provide valuable information about the surrounding environment, such as water density and currents, which can aid in navigation and task completion. As such, it is desirable to address these problems and provide a robust pressure sensing system for underwater applications. In addition, other desirable features and characteristics will become apparent from the subsequent summary and detailed description, and the appended claims, taken in conjunction with the accompanying drawings and this background.

### SUMMARY

Disclosed herein are pressure sensing systems, pressure sensing algorithms, sensors, transmitters and receivers, and related control logic for provisioning sensing systems employing optical fiber pressure sensors, methods for making and methods for operating such systems, and other systems equipped with such transmitters, receivers, and controllers. By way of example, and not limitation, there is presented method and apparatus for providing a fiber optic pressure sensor employing compliant optical fiber coatings combined with the use of π-phase-shifted fiber Bragg gratings to enable high resolution distributed static pressure sensing.

In accordance with an exemplary embodiment, a method for determining a hydrostatic pressure on an optical fiber including transmitting, by an optical transmitter, a light pulse in the optical fiber at a first time, the light pulse having a first spectral profile, detecting, by a photodetector, a reflection of the light pulse from the optical fiber at a second time, the reflection of the light pulse having a second spectral profile, determining, by a processor, a point of reflection along the optical fiber in response to a difference between the first time and the second time, comparing, by the processor, the second spectral profile to a third spectral profile expected from a fiber Bragg grating located at the point of reflection, and determining, by the processor, the hydrostatic pressure at the point of reflection in response to a frequency shift between the second spectral profile and the third spectral profile.

In accordance with another exemplary embodiment, a fiber optic pressure sensor including an optical fiber having a fiber Bragg grating located at a position along the optical fiber, a transmitter configured for transmitting a light pulse into the optical fiber at a first time, wherein the light pulse has a first spectral profile, a photodetector configured for detecting a reflection of the light pulse from the optical fiber at a second time, wherein the reflection of the light pulse has a second spectral profile, and a processor for estimating a hydrostatic pressure at the position along the optical fiber in response to a frequency shift between the second spectral profile and an expected spectral profile resulting from the reflection of the first spectral profile from the fiber Bragg grating.

In accordance with another exemplary embodiment, a vehicle control system including an optical fiber having a fiber Bragg grating located at a position along the optical fiber, a controller having a transmitter configured for transmitting a light pulse into the optical fiber at a first time, wherein the light pulse has a first spectral profile and a control signal for controlling a remotely controlled vehicle, a photodetector configured for detecting a reflection of the light pulse from the optical fiber at a second time, wherein the reflection of the light pulse has a second spectral profile, and a processor for estimating a hydrostatic pressure at the position along the optical fiber in response to a frequency shift between the second spectral profile and an expected spectral profile resulting from the reflection of the first spectral profile from the fiber Bragg grating, wherein the processor is further operative for generating the control signal in response to the hydrostatic pressure, and the remotely controlled vehicle communicatively coupled to the controller via the optical fiber and for adjusting a depth of the remotely controlled vehicle in response to the control signal.

Other objects, advantages and novel features of the exemplary embodiments will become more apparent from the following detailed description of exemplary embodiments and the accompanying drawings.

### BRIEF DESCRIPTION OF DRAWINGS

The above-mentioned and other features and advantages of the disclosed methods and systems for estimating a hydrostatic pressure using an optical fiber, and the manner of attaining them, will become more apparent and the system and method will be better understood by reference to the following description of exemplary embodiments taken in conjunction with the accompanying drawings.

FIG. 1 illustrates an exemplary application for use of the fiber optic pressure sensor according to embodiments of the present disclosure.

FIG. 2 illustrates an exemplary configuration for a fiber optic pressure sensor according to embodiments of the present disclosure.

FIG. 3 shows another exemplary configuration for a fiber optic pressure sensor according to embodiments of the present disclosure;

FIG. 4 illustrates a block diagram of an exemplary configuration of a pressure sensing system using a pressure sensing optical fiber according to embodiments of the present disclosure;

FIG. 5 shows a flowchart illustrative of an exemplary method for controlling a fiber optic pressure sensor according to embodiments of the present disclosure are shown.

The exemplifications set out herein illustrate preferred embodiments of the invention, and such exemplifications are not to be construed as limiting the scope of the invention in any manner.

### DETAILED DESCRIPTION

The following detailed description is merely exemplary in nature and is not intended to limit the invention or the application and uses of the invention. Furthermore, there is no intention to be bound by any theory presented in the preceding background or the following detailed description. Various non-limiting embodiments are presented for fiber optic pressure sensors

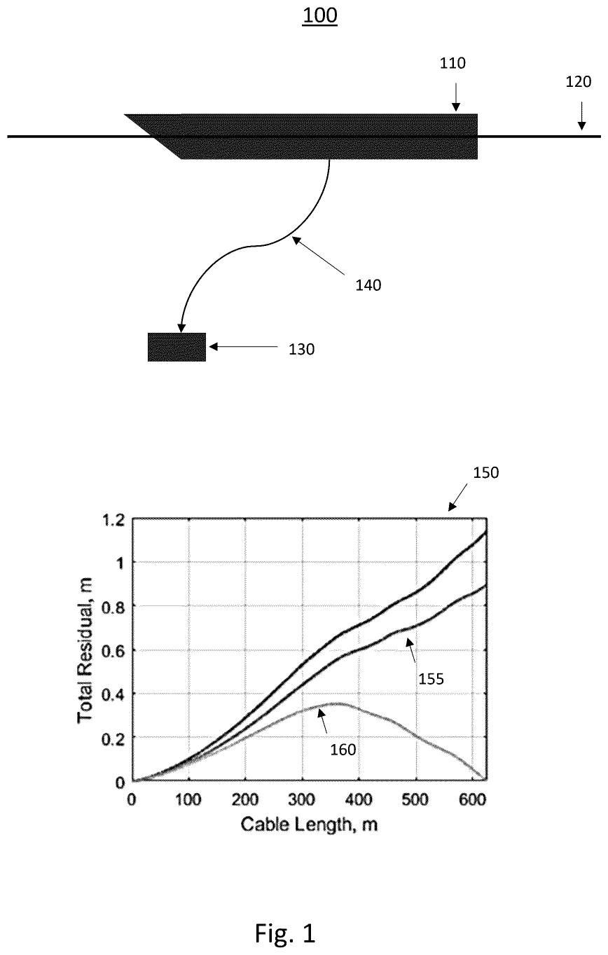

Turning now to FIG. 1, an exemplary application 100 for use of the fiber optic pressure sensor according to embodiments of the present disclosure is shown. The exemplary application 100 includes a tethered vehicle 130 remotely controlled via a tether 140 from a surface vehicle 110 floating on a surface 120 of a body of water. The tether 140 can include at least one optical fiber coupled to at least one optical fiber pressure sensor for estimating a pressure distribution along the tether 140.

Depth measurements play a critical role in underwater robotics by providing essential information about the environment and a vehicle's position relative to it. In the context of underwater tethered vehicles, depth measurements serve as a valuable predictor to enhance tether shape sensing. Tether shape sensing is crucial for maintaining accurate control and navigation of the vehicle, especially in complex underwater environments with currents and obstacles. One of the primary challenges faced by underwater tethered vehicles is inertial walk. Inertial walk refers to the gradual accumulation of errors in the vehicle's position and orientation estimates due to the limitations of inertial navigation systems. Depth measurements help to mitigate the effects of inertial walk by providing an independent source of position information. By combining depth measurements with inertial data, the vehicle's navigation system can achieve a more accurate and stable estimate of its position and orientation improving the accuracy and stability of the vehicle's navigation system. The use of depth measurements to enhance tether shape sensing and overcome inertial walk has a wide range of applications in underwater robotics. This technology enables more precise and reliable underwater operations, such as inspection, survey, and intervention tasks.

Optical fiber pressure sensors offer a non-invasive method for measuring pressure distribution along a fiber as external pressure induces changes in the fiber's refractive index and optical path length, altering the transmitted light. By detecting these changes, sensors enable continuous, real-time monitoring with high spatial resolution. Advantages include high sensitivity, immunity to electromagnetic interference, and suitability for harsh environments. Standard fiber optic sensors however are insensitive to pressure because induced axial strain and induced change in refractive index tend to cancel each other out. The currently proposed optical fiber pressure sensor configuration amplifies the axial strain and makes the fiber more sensitive, while also enhancing the measurement precision by making a narrower spectral profile. For fiber shape sensing in water, telemetry from the optical fiber pressure sensor can constrain the depth of a test article, improving the 3D shape solution.

The graph 150 is illustrative of total residual in meters versus cable length for various shape sensing technologies. In the context of underwater robotics, total residual refers to the error in the predicted position of the tether cable at each point along the cable. The total residual curve 155 for a cable employing the fiber optic pressure sensor according to the disclosed embodiments is illustrative of the reduced total residual realized over other pressure sensing technologies. The position error of the solution curve 160 is further shown when depth is known at all points and the precise coordinates of the far endpoint are known in all three spatial dimensions, for example, when a Z error is constrained to zero over the full tether cable and the X, Y, and Z errors are constrained to 0 at the far endpoint of the tether cable.

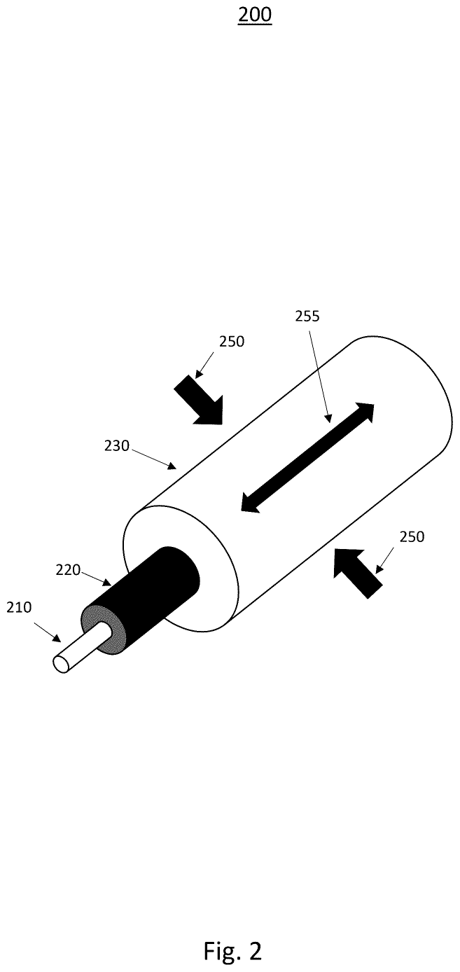

Turning now to FIG. 2, an exemplary configuration for a fiber optic pressure sensor 200 according to embodiments of the present disclosure is shown. The fiber optic pressure sensor 200 is configured with an optical fiber 210, an optical fiber coating 220, and a compliant coating 230. The exemplary fiber optic pressure sensor 200 is designed to measure hydrostatic pressure at discrete points along an underwater cable or tether. The fiber optic pressure sensor 200 converts distributed variations in hydrostatic pressure along a cable or tether into corresponding changes in the optical reflection spectrum of a series of fiber optic sensors. These distributed variations are quantified by converting distributed pressure variations into corresponding changes in the optical reflection spectrum of a series of fiber optic sensors enabling real-time, high-precision water depth measurement at discrete points along the cable. By leveraging the power of fiber optic technology, this system offers a reliable and efficient solution for monitoring and understanding underwater environments.

In some exemplary embodiments, the large-diameter, mechanically-bonded compliant coating 230 is operative to amplify the typically weak coupling between hydrostatic pressure 250 exerted by the water on the fiber optic pressure sensor 200 at depth and the strain on the silica fiber 210. Although the silica fiber 210 is resistant to changes in its diameter due to orthogonal pressure, being surrounded by the mechanically-bonded compliant coating 230 on all sides forces the silica fiber to expand axially inducing a measurable change in its reflection spectrum. In some exemplary embodiments, the fiber optic sensor 200 can be coupled with an additional fiber without a mechanically bonded compliant coating, allowing for other strain effects, such as axial strain on a cable, to be distinguished from pressure effects.

The fiber optic sensor 200 can incorporate a π-phase-shifted fiber Bragg grating (FBG) to produce a narrow spectral notch in the reflected spectrum, reducing uncertainty in cross-correlation measurements and enhancing the precision of pressure readings. The combination of the large-diameter compliant coating 230 and the π-phase-shifted FBG facilitates pressure measurements at multiple points along a cable or tether to enable the fiber optical sensor 200 to accurately monitor the profile of underwater structures, such as buoys or pipelines. The fiber optic sensor 200 configuration can further be used in conjunction with other techniques to provide more accurate and comprehensive shape information, to provide a robust and precise solution for underwater monitoring and measurement.

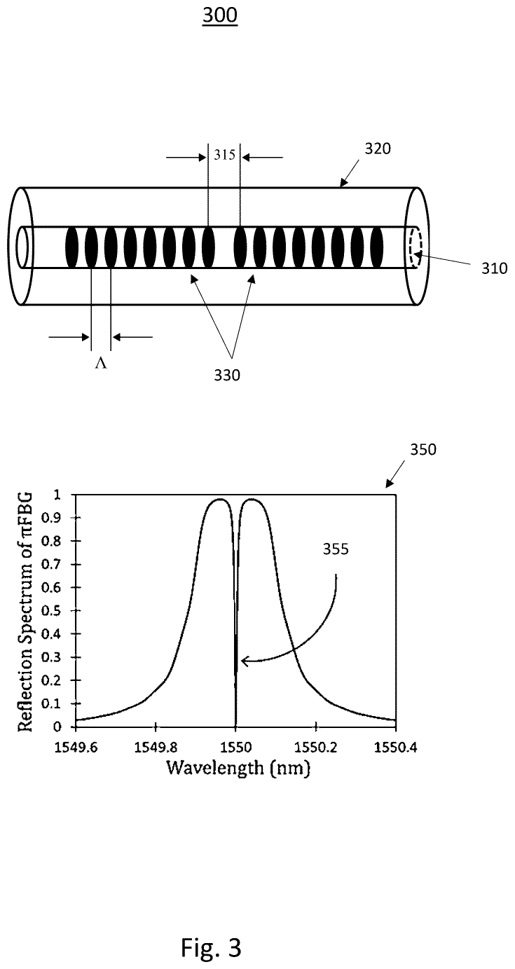

Turning now to FIG. 3, an exemplary configuration for a fiber optic pressure sensor 300 according to embodiments of the present disclosure are shown. The exemplary fiber optic pressure sensor 300 is shown with an optical fiber 310, such as a silica fiber, having a phase gap 315, a mechanically-bonded compliant coating 320, and a π-phase-shifted FBG 330. A π-phase-shifted FBG can be constructed by exposing a germanium-doped silica fiber to a periodic pattern of UV light. This pattern is created using a phase mask, which is a template with a specific grating structure. The UV light induces a refractive index change in the fiber core, creating a periodic structure that reflects a specific wavelength of light. To create the π-phase shift, the phase mask is translated by half the grating period during the exposure process. This introduces a discontinuity in the grating structure, resulting in a narrow transmission window within the reflection band of the FBG. This unique characteristic makes π-phase-shifted FBGs highly sensitive to changes in strain and temperature, making them ideal for various sensing applications. In a standard FBG, the optical bandwidth of the reflection spectrum can typically range from two hundred and fifty pm and higher. In a π-phase-shifted FBG, there is an additional very narrow notch in the reflected spectrum. The narrow spectral feature reduces uncertainty in a cross-correlation between the reflected spectrum and a known spectral profile.

As the optical fiber 310 is subject to a hydrostatic pressure, the mechanically-bonded compliant coating 320 on all sides forces the silica fiber to expand axially, thereby increasing the spacing between the individual phase masks of the π-phase-shifted FBG 330. The axial strain on the optical fiber 310 induces a precisely-measurable change in the reflection spectrum of the embedded π-phase-shifted FBG 330. The axial strain on the fiber changes the spatial period (Λ) of refractive index variation along the axial dimension, which in turn changes the central Bragg wavelength (λ_{B}) reflected back toward the light source according to the following formula, with n_{eff} representing the effective index of the optical fiber 310.

λ_{B}=2n_{eff}Λ

The combination of the two enabling technologies including the large diameter compliant coating 320 and the π-phase shifted FBG 330 enable profile monitoring applications, such as buoys, maneuvers, and seasonal data. In some exemplary embodiments, shape sensing can be used independently if sufficient resolution can be obtained, wherein pressure sensing can be much more effective. For shape sensing applications discrete acoustic transponders can be employed to provide shape sensing correction data. Physics models can be used to provide shape sensing correction data. All of these alternatives are additive and synergistic.

A graph 350 of an exemplary spectral response of a π-phase shifted FBG 330 is shown. In a standard FBG the optical bandwidth of the reflection spectrum can be 250 pm and higher. In a π-phase-shifted FBG, an additional very narrow reflection notch 355 is induced in the reflected spectrum. The narrow reflection notch 355 can be used to reduce uncertainty in a cross-correlation between the reflected spectrum and a known spectral profile.

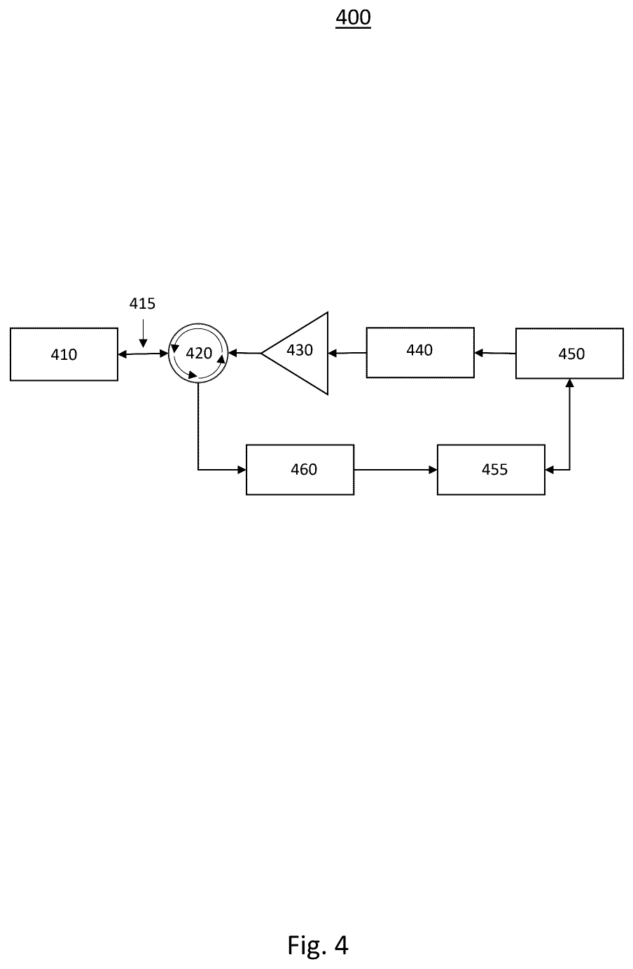

Turning now to FIG. 4, a block diagram of an exemplary configuration of a pressure sensing system 400 using a pressure sensing optical fiber 415 according to embodiments of the present disclosure is shown. The exemplary system 400 can include a device under control (DUC) 410, optical circulator 420, transmit amplifier 430, transmitter 440, a system controller 450, receiver 455 and receiver optical signal conditioner 460. In some exemplary embodiments, the system 400 can be configured as a bi-directional communications system for transmitting and receiving information from a system controller 450 to the DUC 410, via a fiber optic cable 415.

The exemplary pressure sensing system 400 is configured to transmit light within a uniquely configured optical cable 415 including a plurality of π-phase-shifted FBGs positioned periodically within the optical cable 415. As a hydrostatic pressure is applied to the optical cable 415, a mechanically-bonded compliant coating is compressed by the pressure, introducing an axial pressure on the optical fiber 415, thereby expanding the fiber proportionally to the hydrostatic pressure. As the optical fiber 415 is expanded, spatial period of the refractive index of the π-phase-shifted FBGs increases, thereby altering the optical response of the FBG. Specifically, the frequency response of the reflection spectrum of the FGB will be shifted. By knowing the propagation time of the transmitted light and the reflection spectrum at various time intervals, the hydrostatic pressure at each of the plurality of π-phase-shifted FBGs positioned periodically within the optical cable 415 can be estimated.

In some exemplary embodiments, the system controller 450 can generate a control signal to initiate an optical transmission through the optical fiber 415. The control signal can be indicative of an amplitude and wavelength of the optical signal. The control signal is coupled to the transmitter 440. The transmitter 440 is configured to generate a light pulse in response to the control at a known wavelength and at a known time. In some exemplary embodiments, the transmitter can be a frequency swept optical source and the light pulse can include a laser light having a frequency of light is continuously and rapidly changed over a specific frequency range. This light pulse is then coupled to the optical circulator 420 for coupling to the optical fiber 415. In some exemplary embodiments, the light pulse can be amplified via an amplifier, such as an Erbium-Doped Fiber Amplifier (EDFA) 430 before coupling to the optical circulator 420.

The EDFA 430 can be configured for amplifying the light signal generated by the transmitter 440 at specific wavelengths to effectively strengthen the desired light pulses. The selective amplification nature of EDFAs is advantageous as they can be configured to amplify light within a narrow wavelength band. This selectivity ensures that the EDFA 430 primarily amplifies the signal of interest while minimizing the amplification of any background noise or unwanted light present in the optical pulse generated by the transmitter 440.

The optical circulator 420, such as a three-port optical circulator, can be a passive, non-reciprocal device used to direct the flow of light within the system 400. The optical circulator 420 involves routing incoming light from any port to the subsequent port in the sequence. For instance, in a three port optical circulator, light injected into port 1 exits through port 2 and light injected into port 2 exits through port 3. In transmit mode, the light is received from the EDFA 430 at a first port of the optical circulator 120 and is coupled to the optical fiber 415 from a second port of the optical circulator 420. In receive mode, light received from the optical fiber 415 is received at the second port of the optical circulator 120 and is directed towards the optical signal conditioner 460 from a third port of the optical circulator 420.

The optical signal conditioner 460 is configured to receive the reflected optical pulses from the optical circulator 420 and process the received optical signals for signal filtering and amplification. Specialized optical filters tuned to the specific wavelength of the transmitted laser effectively remove unwanted light, enhancing the desired signal. The optical signal conditioner 460 can include an optical amplifier to further bolster the often-weak optical pulses. These amplifiers significantly boost the strength of the received signal before conversion. The conditioned optical signal can then be coupled to a receiver 455 for further processing.

In some exemplary embodiments, the receiver 455 is configured to receive the conditioned optical signal from the optical signal conditioner 460 and to detect a spectral profile and propagation time of the light pulse. This information can then be coupled to the controller 450 and/or an additional processor for determination of a hydrostatic pressure at a particular π-phase shifted FBG along the optical fiber 415.

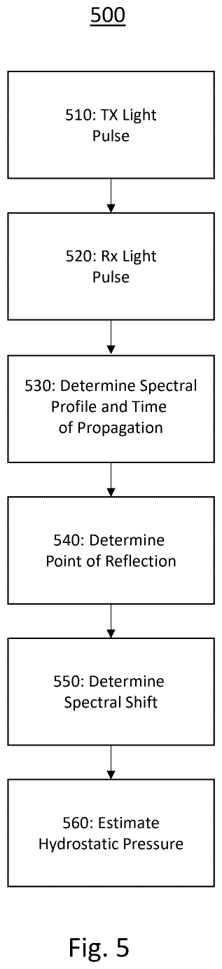

Turning now to FIG. 5, a flow diagram of illustrating an exemplary method 500 for controlling a fiber optic pressure sensor according to embodiments of the present disclosure is shown. The exemplary method 500 is first operative to transmit 510 a light pulse within an optical fiber configured with at least one periodically spaced π-phase shifted FBG embedded within the optical fiber at a known location along the length of the optical fiber. The method 500 is next operative to detect 520 a reflected light pulse at a second time. In some exemplary embodiments, a light detector, such as a photodiode or a photodiode array, can be used to convert the received light signal into an electrical signal. The method 500 next determines 530 the time of reception and a spectral profile of the received light pulse. The method next determines 540 a point of reflection on the optical fiber in response to a propagation time determined in response to a difference between the time of reception and the time of transmit. The point of reflection along the optical fiber is then determined in response to the speed of light multiplied by the propagation time divided by two. The method 500 next determines a difference 550 between an expected spectral profile at the transmit time reflected from the π-phase-shifted FBG at the point of reflection and the spectral profile of the received light pulse. A magnitude of the frequency shift of the spectral profiles is then used to estimate 560 a hydrostatic pressure at the point of reflection. The frequency shift results from a change in spatial period of the refractive index of the π-phase-shifted FBG at the point of reflection due to the axial expansion of the optical fiber as a result of the compression of the mechanically-bonded compliant coating due to hydrostatic pressure.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those of ordinary skill in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

As used herein, the term processor refers to any hardware, software embodied in a medium, firmware, electronic control component, processing logic, and/or processor device, individually or in any combination, including without limitation: application specific integrated circuit (ASIC), an electronic circuit, a field programmable gate array (FPGA), a processor (shared, dedicated, or group) and memory that executes one or more software or firmware programs, a combinational logic circuit, and/or other suitable components that perform the described algorithms.

It is further noted that the systems and methods may be implemented on various types of data processor environments (e.g., on one or more data processors) which execute instructions (e.g., software instructions) to perform operations disclosed herein. Non-limiting examples include implementation on a single general-purpose computer or workstation, or on a networked system, or in a client-server configuration, or in an application service provider configuration. For example, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein. For example, a computer can be programmed with instructions to perform the various steps of the flowcharts described herein. The software components and/or functionality may be located on a single computer or distributed across multiple computers.

What is claimed is:

1. A method for determining a hydrostatic pressure on an optical fiber comprising:
transmitting, by an optical transmitter, a light pulse in the optical fiber at a first time, the light pulse having a first spectral profile;
detecting, by a photodetector, a reflection of the light pulse from the optical fiber at a second time, the reflection of the light pulse having a second spectral profile;
determining, by a processor, a point of reflection along the optical fiber in response to a difference between the first time and the second time;
comparing, by the processor, the second spectral profile to a third spectral profile expected from a fiber Bragg grating located at the point of reflection; and
determining, by the processor, the hydrostatic pressure at the point of reflection in response to a frequency shift between the second spectral profile and the third spectral profile.

2. The method for determining the hydrostatic pressure on the optical fiber of claim 1 wherein the fiber Bragg grating is a π-phase-shifted fiber Bragg grating and wherein the third spectral profile includes a reflection notch at a center of a reflection band of the fiber Bragg grating.

3. The method for determining the hydrostatic pressure on the optical fiber of claim 1 wherein the optical fiber is a silica optical fiber and wherein the silica optical fiber is encapsulated by a compliant coating such that the hydrostatic pressure induces an orthogonal compression force on the compliant coating which induces an axial force on the silica optical fiber increasing a spatial period of a refractive index of the fiber Bragg grating.

4. The method for determining the hydrostatic pressure on the optical fiber of claim 1 wherein the optical fiber includes a plurality of fiber Bragg gratings at a plurality of known locations along the optical fiber and wherein the third spectral profile is determined in response to the point of reflection.

5. The method for determining the hydrostatic pressure on the optical fiber of claim 1 wherein the frequency shift between the second spectral profile and the third spectral profile results from a variation of a spatial period of a refractive index of the fiber Bragg grating in response to the hydrostatic pressure.

6. The method for determining the hydrostatic pressure on the optical fiber of claim 1 further including a remote control vehicle communicatively coupled to a controller operative to control a position of the remote control vehicle in response to the hydrostatic pressure.

7. The method for determining the hydrostatic pressure on the optical fiber of claim 1 wherein the optical fiber includes a plurality of fiber Bragg gratings at a plurality of known locations along the optical fiber and wherein the processor is further configured for determining a plurality of hydrostatics pressures corresponding to the plurality of known locations in response a plurality of reflections of the light pulse.

8. The method determining the hydrostatic pressure on the optical fiber of claim 7 wherein the plurality of hydrostatic pressures are used to determine a tether shape of a tether including the optical fiber for communicatively coupling a remotely operated vehicle with a remotely operated vehicle controller.

9. The method for determining the hydrostatic pressure on the optical fiber of claim 1 wherein an axial force is exerted on the optical fiber by a compression of a compliant coating on the optical fiber by the hydrostatic pressure.

10. A fiber optic pressure sensor comprising:
an optical fiber having a fiber Bragg grating located at a position along the optical fiber;
a transmitter configured for transmitting a light pulse into the optical fiber at a first time, wherein the light pulse has a first spectral profile;
a photodetector configured for detecting a reflection of the light pulse from the optical fiber at a second time, wherein the reflection of the light pulse has a second spectral profile; and
a processor for estimating a hydrostatic pressure at the position along the optical fiber in response to a frequency shift between the second spectral profile and an expected spectral profile resulting from the reflection of the first spectral profile from the fiber Bragg grating.

11. The fiber optic pressure sensor of claim 10 wherein the fiber Bragg grating is ππ-phase-shifted fiber Bragg grating and wherein the expected spectral profile includes a reflection notch at a center of a reflection band of the fiber Bragg grating.

12. The fiber optic pressure sensor of claim 10 wherein the optical fiber includes a plurality of fiber Bragg gratings at a plurality of known locations along the optical fiber and wherein the expected spectral profile is determined in response to the position.

13. The fiber optic pressure sensor of claim 10 wherein the optical fiber is a silica optical fiber and wherein the silica optical fiber is encapsulated by a compliant coating such that the hydrostatic pressure induces an orthogonal compression force on the compliant coating which induces an axial force on the silica optical fiber increasing a spatial period of a refractive index of the fiber Bragg grating.

14. The fiber optic pressure sensor of claim 10 further including a remote control vehicle communicatively coupled to a controller operative to control the remote control vehicle in response to the hydrostatic pressure.

15. The fiber optic pressure sensor of claim 10 wherein the optical fiber includes a plurality of fiber Bragg gratings at a plurality of known locations along the optical fiber and wherein the processor is further configured for determining a plurality of hydrostatic pressures corresponding to the plurality of known locations in response a plurality of reflections of the light pulse.

16. The fiber optic pressure sensor of claim 15 wherein the plurality of hydrostatic pressures are used to determine a tether shape of a tether including the optical fiber for communicatively coupling a remotely operated vehicle with a remotely operated vehicle controller.

17. The fiber optic pressure sensor of claim 10 wherein an axial force is exerted on the optical fiber by a compression of a compliant coating on the optical fiber by the hydrostatic pressure.

18. The fiber optic pressure sensor of claim 10 wherein the frequency shift between the second spectral profile and the third spectral profile results from a variation of a spatial period of a refractive index of the fiber Bragg grating in response to the hydrostatic pressure.

19. A vehicle control system comprising:
an optical fiber having a fiber Bragg grating located at a position along the optical fiber;
a controller including:
a transmitter configured for transmitting a light pulse into the optical fiber at a first time, wherein the light pulse has a first spectral profile and a control signal for controlling a remotely controlled vehicle;
a photodetector configured for detecting a reflection of the light pulse from the optical fiber at a second time, wherein the reflection of the light pulse has a second spectral profile; and
a processor for estimating a hydrostatic pressure at the position along the optical fiber in response to a frequency shift between the second spectral profile and an expected spectral profile resulting from the reflection of the first spectral profile from the fiber Bragg grating, wherein the processor is further operative for generating the control signal in response to the hydrostatic pressure; and
the remotely controlled vehicle communicatively coupled to the controller via the optical fiber and for adjusting a depth the remotely controlled vehicle in response to the control signal.

20. The vehicle control system of claim 19 wherein the fiber Bragg grating is π-phase-shifted fiber Bragg grating and wherein the expected spectral profile includes a reflection notch at a center of a reflection band of the fiber Bragg grating and wherein the control signal is indicative of a directional control.
